(19) United States
(12) Patent Application Publication
(10) Pub. No.: US 2016/0220981 A1
(43) Pub. Date: Aug. 4, 2016

(54) WATER-ABSORBING RESIN AND PREPARING METHOD THEREOF

(71) Applicants: SK INNOVATION CO., LTD, Seoul (KR); SK GLOBAL CHEMICAL CO., LTD., Seoul (KR)

(72) Inventors: Byoung-Tak YIM, Daejeon (KR); Du-Youn KA, Daejeon (KR); Byoung-Cheon JO, Seoul (KR)

(21) Appl. No.: 15/011,701

(22) Filed: Feb. 1, 2016

(30) Foreign Application Priority Data
Jan. 30, 2015 (KR) 10-2015-0014769

(51) Int. Cl. B01J 20/26; B01J 20/28; B01J 20/30; B01J 20/32; C08F 220/06; C08J 3/24

(52) U.S. Cl. CPC B01J 20/267; C08F 220/06; C08J 3/24; B01J 20/3085; B01J 20/32; B01J 20/3014; B01J 20/28011; C08J 2333/02

(57) ABSTRACT

A water-absorbing resin and a method of preparing the same, and more specifically, to a method of preparing the water-absorbing resin includes crosslinking and polymerization of an unsaturated monomer including an acrylic acid monomer in the presence of a first internal crosslinking agent and a second internal crosslinking agent having a lower reactivity than the first internal crosslinking agent, thereby preparing a water-absorbing resin having significantly improved absorbency due to a uniform crosslinking structure and a suitable degree of crosslinking.

### CROSS-REFERENCE TO RELATED APPLICATION

This application claims priority to and the benefit of Korean Patent Application No. 10-2015-0014769, filed on Jan. 30, 2015, the disclosure of which is incorporated herein by reference in its entirety.

### BACKGROUND

1. Field of the Invention

The present invention relates to a water-absorbing resin and a method of preparing the same.

2. Discussion of Related Art

The absorption mechanism of a water-absorbing resin is controlled by an osmotic pressure attributable to the difference in electrical attraction of electric charges of polymer electrolytes, the affinity between water and polymer electrolytes, and the interaction of molecular expansion due to the repulsive force between polymer electrolyte ions and expansion suppression resulting from crosslinking. In other words, the absorption capacity of the water-absorbing resin depends on the aforementioned affinity and molecular expansion, and the absorption rate depends greatly on the osmotic pressure of an absorbent polymer itself. Accordingly, the molecular expansion and osmotic pressure of absorbent polymer chains rely on introduced crosslinking density and distribution, or types of crosslinking agents.

When the absorption amount of the water-absorbing resin increases, the flow of an absorbed liquid is disturbed due to an adhesion phenomenon of absorbent resin particles swelled in a liquid. In order to resolve this problem, there is a method of preparing the absorbent resin of which the surfaces of particles are solidified by the reaction of the surface of the absorbent resin particles with a crosslinking agent. Such an absorbent resin with a core-shell type structure actually has increased absorbency and liquid permeability under a certain load, and thus the water-absorbing resin having excellent absorbency and absorbency under pressure may be prepared.

A high degree of internal crosslinking of a gel-type resin is required to facilitate the fragmentation of the gel-type resin produced by internal crosslinking in the production process of the water-absorbing resin. However, when the degree of internal crosslinking is high, there is a problem of low absorbency. That is, it is advantageous to increase the degree of internal crosslinking for mass production, but there is a problem of decreased absorbency when the crosslinking density increases.

### SUMMARY

An aspect of the present invention is directed to providing a water-absorbing resin having significantly improved absorbency.

According to an aspect of the present invention, there is provided a method of preparing a water-absorbing resin including, crosslinking and polymerization of an unsaturated monomer including an acrylic acid monomer in the presence of a first internal crosslinking agent and a second internal crosslinking agent having a lower reactivity than the first internal crosslinking agent.

The first internal crosslinking agent may be at least one selected from the group consisting of N,N′-methylenebis(meth)acrylamide, (poly)ethylene glycol di(meth)acrylate, (poly)propylene glycol di(meth)acrylate, trimethylolpropane tri(meth)acrylate, glycerol tri(meth)acrylate, glycerol acrylate methacrylate, ethyleneoxide modified trimethylolpropane tri(meth)acrylate, pentaerythritol hexa(meth)acrylate, triallyl cyanurate, triallyl isocyanurate, triallyl phosphate, triallylamine, poly(meth)allyloxy alkane, (poly)ethylene glycol diglycidyl ether, glycerol diglycidyl ether, ethylene glycol, polyethylene glycol, propylene glycol, glycerin, pentaerythritol, ethylenediamine, ethylene carbonate, propylene carbonate, polyethyleneimine and glycidyl (meth)acrylate.

The second internal crosslinking agent may be a compound represented by the following Formula 1:

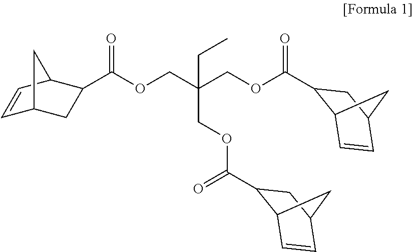 [SMILES: CCC(COC(=O)C1CC2C=CC1C2)(COC(=O)C1CC2C=CC1C2)COC(=O)C1CC2C=CC1C2]

The content of the second internal crosslinking agent may be in a range of 0.001 to 2 mol % based on a total content of the unsaturated monomer.

The method of preparing a water-absorbing resin may further include reaction of a product obtained by the crosslinking and polymerization with a polyvalent metal salt solution to crosslink the product.

The reaction with the polyvalent metal salt solution may be performed by impregnating the product in the polyvalent metal salt solution or spraying or dripping the polyvalent metal salt solution on the product.

The reaction with the polyvalent metal salt solution may be performed by kneading the product with the polyvalent metal salt solution.

The polyvalent metal salt solution may be solution of at least one polyvalent metal salt selected from the group consisting of aluminum chloride, polyaluminum chloride, aluminum sulfate, aluminum acetate, aluminum potassium bis sulfate, aluminum sodium bis sulfate, potassium alum, ammonium alum, sodium alum, sodium aluminate, calcium chloride, calcium acetate, magnesium chloride, magnesium sulfate, magnesium acetate, zinc chloride, zinc sulfate, zinc acetate, zirconium chloride, zirconium sulfate and zirconium acetate.

According to another aspect of the present invention, there is provided a method of preparing a water-absorbing resin, including: crosslinking and polymerizing an unsaturated monomer including an acrylic acid monomer in the presence of an internal crosslinking agent; and reacting a product obtained by the crosslinking and polymerization with a polyvalent metal salt solution to crosslink the product.

The internal crosslinking agent may be at least one selected from the group consisting of N,N-methylenebis(meth)acrylamide, (poly)ethylene glycol di(meth)acrylate, (poly)propylene glycol di(meth)acrylate, trimethylolpropane tri(meth)acrylate, glycerol tri(meth)acrylate, glycerol acrylate methacrylate, ethyleneoxide modified trimethylolpropane tri(meth)acrylate, pentaerythritol hexa(meth)acrylate, triallyl cyanurate, triallyl isocyanurate, triallyl phosphate, triallylamine, poly(meth)allyloxy alkane, (poly)ethylene glycol diglycidyl ether, glycerol diglycidyl ether, ethylene glycol, polyethylene glycol, propylene glycol, glycerin, pentaerythritol, ethylenediamine, ethylene carbonate, propylene carbonate, polyethyleneimine and glycidyl (meth)acrylate. The reaction with the polyvalent metal salt solution may be performed by impregnating the product in the polyvalent metal salt solution or spraying or dripping the polyvalent metal salt solution on the product.

The reaction with the polyvalent metal salt solution may be performed by kneading the product with the polyvalent metal salt solution.

The polyvalent metal salt solution may be solution of at least one polyvalent metal salt selected from the group consisting of aluminum chloride, polyaluminum chloride, aluminum sulfate, aluminum acetate, aluminum potassium bis sulfate, aluminum sodium bis sulfate, potassium alum, ammonium alum, sodium alum, sodium aluminate, calcium chloride, calcium acetate, magnesium chloride, magnesium sulfate, magnesium acetate, zinc chloride, zinc sulfate, zinc acetate, zirconium chloride, zirconium sulfate and zirconium acetate.

According to still another aspect of the present invention, there is provided a water-absorbing resin, in which a content of a water-soluble fraction is 15 wt % or less based on the total weight of the resin, an absorbency against pressure at 0.3 psi with respect to a saline solution including sodium chloride at 0.9 wt % is 25 g/g or more, and a water-soluble fraction shear index A/B represented by the following Expression 1 is in the range of 0.1×10⁻⁵ (s) to 10×10⁻⁵ (s):

A/B [Expression 1]

(in Expression 1, A is an absolute gradient of viscosity with respect to a shear rate of an ultrapure water solution with a content of a water-soluble fraction of 0.2 wt % of the water-absorbing resin, and is represented by the following Expression 2, and B is a viscosity at a shear rate of 10/s of an ultrapure water solution including a water-soluble fraction of a water-absorbing resin after immersing a water-absorbing resin in ultrapure water of which the weight is 400 times the weight of the water-absorbing resin and stirring a mixed solution at 300 rpm for 60 minutes)

(Vis(100)−Vis(10))/(100−10) [Expression 2]

(in Expression 2, Vis (100) is a viscosity of an aqueous solution at a shear rate of 100/s, and Vis (10) is a viscosity of an aqueous solution at a shear rate of 10/s)

The water-absorbing resin may be prepared by grinding a base resin and carrying out surface crosslinking of the base resin.

The base resin may be an acrylic acid polymer.

The A/B may be in the range of 0.5×10⁻⁵ (s) to 7×10⁻⁵ (s).

The A/B may be in the range of 1×10′ (s) to 5×10′ (s).

The absorbency against pressure may be in a range of 25 to 45 g/g.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic view illustrating the configuration of a device measuring absorbency against pressure.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

According to an embodiment of the present invention, a method of preparing the water-absorbing resin includes crosslinking and polymerizing an unsaturated monomer including an acrylic acid monomer in the presence of a first internal crosslinking agent and a second internal crosslinking agent having a lower reactivity than the first internal crosslinking agent, thereby preparing a water-absorbing resin having significantly improved absorbency due to a uniform crosslinking structure and a suitable degree of crosslinking.

According to another embodiment of the present invention, a method of preparing the water-absorbing resin includes crosslinking and polymerizing an unsaturated monomer including an acrylic acid monomer in the presence of an internal crosslinking agent, and reacting a product obtained by the crosslinking and polymerization with a polyvalent metal salt solution to crosslink the product.

Hereinafter, the present invention will be described in detail.

[Water-Absorbing Resin]

A water-absorbing resin according to an embodiment of the present invention has a content of a water-soluble fraction of 15 wt % or less based on the total weight of the resin, an absorbency against pressure at 0.3 psi of 25 g/g or more with respect to a saline solution including sodium chloride at 0.9 wt %, and a water-soluble fraction shear index A/B of 0.1×10⁻⁵ (s) to 10×10⁻⁵ (s) represented by the following Expression 1:

A/B [Expression 1]

where A is an absolute gradient of viscosity with respect to a shear rate of an ultrapure water solution with a content of a water-soluble fraction of 0.2 wt % of the water-absorbing resin, and is represented by the following Expression 2, and B is a viscosity at a shear rate of 10/s of an ultrapure water solution including a water-soluble fraction of a water-absorbing resin after immersing a water-absorbing resin in ultrapure water of which the weight is 400 times the weight of the water-absorbing resin and stirring a mixed solution at 300 rpm for 60 minutes.

(Vis(100)−Vis(10))/(100−10) [Expression 2]

where Vis (100) is a viscosity of an aqueous solution at a shear rate of 100/s, and Vis (10) is a viscosity of an aqueous solution at a shear rate of 10/s.

In the present specification, the water-absorbing resin refers to a water-swelling and water-insoluble polymer gelling agent. Further, a water-swelling property denotes that CRC (absorbency against non-pressure) defined by ERT442.2-02 is 5 g/g or more, and water insolubility denotes that Ext (water-soluble fraction) is in a range of 0 to 50 wt %

In the specification, CRC is an abbreviation of Centrifuge Retention Capacity, meaning absorbency against non-pressure. CRC denotes absorbency (g/g) measured after swelling 0.2 g of the water-absorbing resin in a container such as a non-woven bag, a tea bag or the like with respect to a saline solution including sodium chloride at 0.9 wt % for 30 minutes and additionally removing water using a centrifuge.

The water-soluble fraction denotes an acrylic oligomer component (liquid elution content) dissolved in and extracted from water. The water-soluble fraction may be measured according to the following Expression 3 after stirring the water-absorbing resin in water of which the weight is 100 times the total weight of a resin for 1 hour, filtering a prepared slurry using a filter under pressure, and dehumidification-drying extracted components.

Water-soluble fraction (wt %)=(weight of extracted component/weight of initial dried water-absorbing resin)*100. [Expression 3]

Absorbency against pressure denotes absorbency (g/g) after swelling under pressure (load). In the present specification, absorbency against pressure at 0.3 psi with respect to a saline solution denotes absorbency after swelling the water-absorbing resin in a saline solution including sodium chloride at 0.9 wt % at a pressure of 0.3 psi for 1 hour. This may be calculated from the following Expression 4.

Absorbency against pressure (g/g)=(weight (g) of water-absorbing resin after absorption−weight (g) of water-absorbing resin before absorption)/weight (g) of resin before absorption. [Expression 4]

The water-absorbing resin according to an embodiment of the present invention has absorbency against pressure at 0.3 psi of 25 g/g or more, and thus leakage of the absorbed solution may be minimized. The upper limit of absorbency against pressure is not particularly limited, and may be 45 g/g or less, for example, 40 g/g or less in terms of maintenance of a balance between other physical properties. The absorbency against pressure in the above-described range may be obtained by controlling the degree of internal crosslinking, the degree of surface crosslinking or the like, but the present invention is not limited thereto.

The water-absorbing resin according to an embodiment of the present invention has an A/B in the range of 0.1×10⁻⁵ (s) to 10×10⁻⁵(s) represented by Expression 1. When the A/B is 0.1×10⁻⁵(s) or less, the water-soluble fraction of the water-absorbing resin largely increases, and the mobility of the water-soluble fraction is high. The water-absorbing resin is frequently used in hygiene products such as diapers. Here, when the mobility of the water-soluble fraction is high, the water-soluble fraction may be transferred to a human body by a medium of a liquid such as urine, causing hygiene problems. When the A/B is more than 10×10⁻⁵(s), absorbency significantly decreases. The A/B may be, for example, in the range of 0.5×10⁻⁵(s) to 7×10⁻⁵(s), and more particularly, 1×10⁻⁵(s) to 5×10⁻⁵(s) considering that the effect of decreasing an amount of the water-soluble fraction is maximized and the mobility of the water-soluble fraction is suppressed.

The water-absorbing resin according to an embodiment of the present invention prepared by a composition, a content, a process or the like to be described below has the A/B in the above-described range, and also has a low amount and low mobility of the water-soluble fraction. More specifically, when the content of the water-soluble fraction is 15 wt % or less based on the total weight of the resin, stickiness or the like due to liquid elution content may be minimized.

The water-absorbing resin according to the embodiment of the present invention may be prepared by grinding a base resin and carrying out surface crosslinking of the base resin.

Examples of the base resin include: one or at least two of an acrylic acid polymer; a hydrolysate of a starch-acrylonitrile graft polymer; a starch-acrylic acid graft polymer or a neutralized product thereof; crosslinked carboxymethyl cellulose; a saponified product of a vinyl acetate-acrylic acid ester copolymer; a hydrolysate of a acrylonitrile copolymer or acrylamide copolymer or a crosslinked acrylonitrile copolymer or acrylamide copolymer; a carboxyl group-containing crosslinked polyvinyl alcohol-modified product; a crosslinked cationic monomer; crosslinked 2-acrylamide-2-methylpropanesulfonic acid and acrylic acid; a crosslinked isobutylene-(anhydrous) maleic acid copolymer or the like. For example, an acrylic acid polymer may be used as the base resin.

Hereinafter, the case in which the base resin is an acrylic acid polymer will be described in detail, but the present invention is not limited thereto.

An acrylic acid polymer may be a homopolymer or copolymer of an acrylic acid monomer.

In the present specification, the acrylic acid monomer denotes acrylic acid or salts thereof. Examples of the acrylic acid salt include acrylic acid with an alkali metal salt, an ammonium salt, an alkylamine salt or the like, but are not limited thereto.

The acrylic acid copolymer according to an embodiment of the present invention may be polymerized by additionally including an unsaturated monomer which is well-known in the related field in addition to the acrylic acid monomer.

For example, acid group-containing monomers such as β-acryloyl oxy propionic acid, methacrylic acid, (anhydrous) maleic acid, fumaric acid, crotonic acid, itaconic acid, vinyl sulfonic acid, 2-(meth)acrylamide-2-methylpropanesulfonic acid, (meth)acryloxy alkane sulfonic acid, and alkali metal salts, ammonium salts and alkylamine salts thereof; water-soluble or water-insoluble unsaturated monomers such as N-vinyl-2-pyrrolidone, N-vinylacetamide, (meth)acrylamide, N-isopropyl (meth)acrylamide, N,N-dimethyl (meth)acrylamide, 2-hydroxyethyl (meth)acrylate, methoxy polyethylene glycol (meth)acrylate, polyethylene glycol (meth)acrylate, isobutylene, lauryl (meth)acrylate, or the like may be used. One or mixtures of two or more thereof may be used.

The content of the acrylic acid monomer in the acrylic acid polymer according to an embodiment of the present invention is not particularly limited. For example, 70 to 100 mol %, particularly, 90 to 100 mol % of the acrylic acid monomer may be included based on the total monomers for polymerization.

Acid group-containing unsaturated monomers such as acrylic acid monomers or the like may be neutralized to have about a neutral pH in terms of physical properties and pH. For example, neutralization may be performed by alkalis such as sodium hydroxide, potassium hydroxide, lithium hydroxide, ammonium carbonate, sodium carbonate, potassium carbonate, ammonium phosphate, sodium phosphate, etc. The neutralization ratio of an acid group (mol % of neutralized acid groups based on the total acid groups) is generally in the range of 20 to 100 mol %, for example, 30 to 95 mol %, and more particularly, in the range of 40 to 80 mol %. When the neutralization ratio is less than 20%, absorption capacity of the resin is reduced, when the neutralization ratio is more than 80 mol %, most of the resin may be dissolved in water.

Polymers which are crosslinked and polymerized with the acrylic acid monomer are used as a general acrylic acid copolymer. A crosslinked structure may be formed by a self-crosslinking reaction without using a crosslinking monomer, and may also be formed by a crosslinking reaction induced by an internal crosslinking agent such as a crosslinking monomer.

The crosslinking monomer has two or more polymerizable unsaturated groups or two or more reactive groups in a molecule.

Here, this crosslinking monomer is polymerized faster than a general acrylic acid monomer. Accordingly, the degree of crosslinking of the base resin in an initial polymerization reaction is high, but the crosslinking monomer is polymerized fast and exhausted, and thus the degree of crosslinking of the base resin decreases as the polymerization reaction proceeds. Therefore, there is a problem in that absorption capacity is reduced due to non-uniform crosslinking.

However, according to an embodiment of the present invention, an unsaturated monomer including an acrylic acid monomer is polymerized by mixing an internal crosslinking agent. More specifically, an unsaturated monomer including an acrylic acid monomer may be polymerized by mixing a first internal crosslinking agent and a second internal crosslinking agent having a lower reactivity than the first internal crosslinking agent.

In the present specification, crosslinking reactivity denotes reactivity of a crosslinkable functional group. Low crosslinking reactivity denotes that a crosslinkable functional group has low reactivity.

When the unsaturated monomer including the acrylic acid monomer is crosslinked by a reaction with the first internal crosslinking agent, the first internal crosslinking agent is polymerized faster than the unsaturated monomer including the acrylic acid monomer, and exhausted. However, when the second internal crosslinking agent having a lower reactivity than the first internal crosslinking agent is used with the first internal crosslinking agent, sufficient crosslinking is achieved even at a later stage of polymerization reaction, and thus the base resin having uniform crosslinking density may be obtained.

Internal crosslinking agents well known in the related field may be used as the first internal crosslinking agent. Examples of the first internal crosslinking agent include N,N′-methylenebis(meth)acrylamide, (poly)ethylene glycol di(meth)acrylate, (poly)propylene glycol di(meth)acrylate, trimethylolpropane tri(meth)acrylate, glycerol tri(meth)acrylate, glycerol acrylate methacrylate, ethyleneoxide modified trimethylolpropane tri(meth)acrylate, pentaerythritol hexa(meth)acrylate, triallyl cyanurate, triallyl isocyanurate, triallyl phosphate, triallylamine, poly(meth)allyloxy alkane, (poly)ethylene glycol diglycidyl ether, glycerol diglycidyl ether, ethylene glycol, polyethylene glycol, propylene glycol, glycerin, pentaerythritol, ethylenediamine, ethylene carbonate, propylene carbonate, polyethyleneimine, glycidyl (meth)acrylate, etc. One or mixtures of two or more thereof may be used.

The content of the first internal crosslinking agent is not particularly limited, for example, 0.001 to 2 mol %, particularly, 0.005 to 0.5 mol % of the first internal crosslinking agent may be used based on the total monomers included in the polymer for polymerization. When the content of the first internal crosslinking agent is less than 0.001 mol % or more than 2 mol %, absorbency may be insufficient, and the above-described amount of the water-soluble fraction may be difficult to obtain.

Any internal crosslinking agent well known in the related field may be used as the second internal crosslinking agent without particular limitation insofar as an internal crosslinking agent has a lower reactivity than the first internal crosslinking agent. For example, a compound represented by the following Formula 1 may be used:

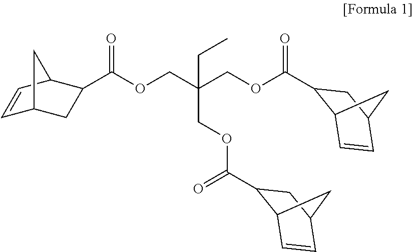 [SMILES: CCC(COC(=O)C1CC2C=CC1C2)(COC(=O)C1CC2C=CC1C2)COC(=O)C1CC2C=CC1C2]

The content of the second internal crosslinking agent is not particularly limited, for example, 0.001 to 2 mol %, particularly, 0.005 to 0.5 mol % of the second internal crosslinking agent may be used based on the total monomers included in the polymer for polymerization. When the content of the second internal crosslinking agent is less than 0.001 mol % or more than 2 mol %, an A/B value in the above-described range may be difficult to obtain.

The first and second internal crosslinking agents may be added together prior to the polymerization of the unsaturated monomer, but the present invention is not limited thereto.

Further, the acrylic acid polymer may be crosslinked by the reaction of the product crosslinked and polymerized in the presence of the first and second internal crosslinking agents with a polyvalent metal salt solution to be described below.

According to the embodiment of the present invention, the acrylic acid polymer may be obtained by crosslinking the product prepared by crosslinking and polymerizing the unsaturated monomer including acrylic acid monomer in the presence of the first and second internal crosslinking agents with a polyvalent metal salt solution.

The polyvalent metal salt solution serves to crosslink the unsaturated monomer including acrylic acid monomer. A general acrylic acid polymer is crosslinked and polymerized by adding the polyvalent metal salt solution, but in such a case, the polymerization reaction rate decreases, and a conversion rate is reduced due to the influence of an attractive force between polyvalent metal ions and unsaturated monomers.

However, according to an embodiment of the present invention, such a problem may be prevented because the polyvalent metal salt solution is added to the acrylic acid polymer for crosslinking after the acrylic acid polymer is crosslinked and polymerized, and thereby the water-absorbing resin having the A/B in the above-described range may be obtained.

Examples of the polyvalent metal salt which may be used in an embodiment of the present invention include aluminum chloride, polyaluminum chloride, aluminum sulfate, aluminum acetate, aluminum potassium bis sulfate, aluminum sodium bis sulfate, potassium alum, ammonium alum, sodium alum, sodium aluminate, calcium chloride, calcium acetate, magnesium chloride, magnesium sulfate, magnesium acetate, zinc chloride, zinc sulfate, zinc acetate, zirconium chloride, zirconium sulfate, zirconium acetate, etc. One or mixtures of two or more thereof may be used.

The content of the polyvalent metal salt is not particularly limited, and for example, may be in the range of 0.001 to 0.1 mol % based on the total content of monomers used in the acrylic acid polymer. When the content of the polyvalent metal salt is less than 0.001 mol %, the effect of improving liquid permeability due to the use of the polyvalent metal salt solution may be low, and when the content of the polyvalent metal salt is more than 0.1 mol %, other physical properties such as absorbency against pressure or the like may be reduced.

Examples of a polymerization initiator used when a monomer is polymerized to obtain the acrylic acid copolymer according to an embodiment of the present invention include a radical polymerization initiator such as potassium persulfate, ammonium persulfate, sodium persulfate, calcium acetate, sodium acetate, potassium carbonate, sodium carbonate, t-butyl hydroperoxide, hydrogen peroxide and 2,2′-azobis (2-amidino-propane) dihydrochloride; a photopolymerization initiator such as 2-hydroxy-2-methyl-1-phenyl-propan-1-one, etc. One or mixtures of two or more thereof may be used.

The content of the polymerization initiator is not particularly limited, for example, 0.001 to 2 mol %, particularly, 0.01 to 0.1 mol % of the polymerization initiator may be used based on the total monomers included in the polymer for polymerization. When the content of the polymerization initiator is less than 0.001 mol %, the amount of residual unreacted monomers may increase, and when the content of the polymerization initiator is more than 2 mol %, control of polymerization may be difficult.

The base resin is ground, and classified as necessary, thereby a particulate base resin may be obtained.

The particle size of the particulate base resin is not particularly limited, for example, may be in the range of 150 to 800 μm, particularly 150 to 600 μm, and more particularly 180 to 500 μm. Further, the ratio of particles having the particle size of less than 150 μm may be in the range of 0 to 8 wt %, for example, 0 to 5 wt % based on the total weight of the particulate base resin.

A surface crosslinking agent used in crosslinking of the surface of the particulate base resin is not particularly limited, and surface crosslinking agents well known in the related field may be used. Examples of the surface crosslinking agent include (i) a polyhydric alcohol compound such as 1,3-propanediol, 1-methyl-1,3-propanediol, 2-methyl-1,3-propanediol, ethylene glycol, diethylene glycol, triethylene glycol, tetraethylene glycol, polyethylene glycol, propylene glycol, dipropylene glycol, polypropylene glycol, 2,3,4-trimethyl-1,3-pentanediol, glycerol, polyglyceryl-2-butene-1,4-diol, 1,4-butanediol, 1,3-butanediol, 1,5-pentanediol, 1,6-hexanediol, meso-erythritol, D-sorbitol, 1,2-cyclohexane dimethanol, hexane diol trimethylolpropane, pentaerythritol or the like; (ii) an epoxy compound such as ethylene glycol diglycidyl ether, polyethylene glycol diglycidyl ether, glycerol polyglycidyl ether, propylene glycol diglycidyl ether, polypropylene glycol diglycidyl ether or the like; (iii) a polyvalent metal compound such as calcium, magnesium, aluminum, and iron hydroxides or chlorides; (iv) an oxazolidinone compound such as N-acyl oxazolidinone, 2-oxazolidinone compounds or the like (U.S. Pat. No. 6,559,239); (iv) an alkylene carbonate compound such as 1,3-dioxolan-2-one (also referred to as “ethylene carbonate”), 4-methyl-1,3-dioxolan-2-one, 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxepan-2-one, or the like; (vi) an oxetane compound and a cyclic urea compound (2-imidazolidinone compound) (US patent application No. 2002/0072471); and (vii) an amino-alcohol compound such as ethanolamine, diethanolamine, triethanolamine, etc. One or mixtures of two or more thereof may be used.

The content of the surface crosslinking agent is not particularly limited, for example, 0.001 to 10 mol %, particularly, 0.01 to 5 mol % of the surface crosslinking agent may be used based on 100 parts by weight of the particulate base resin. When the surface crosslinking agent in the above-described range is used, the absorbency against pressure in the above-described range may be obtained.

[Method of Preparing Water-Absorbing Resin]

Further, an embodiment of the present invention provides a method of preparing the water-absorbing resin.

The method of preparing a water-absorbing resin according to the embodiment of the present invention includes crosslinking and polymerization of an unsaturated monomer including an acrylic acid monomer in the presence of a first internal crosslinking agent and a second internal crosslinking agent having a lower reactivity than the first internal crosslinking agent.

Examples of the acrylic acid monomer include the above-described monomers. In addition, the above-described unsaturated monomers may be copolymerized together. The above-described content of the acrylic acid monomer may be used.

The above-described content of the first crosslinking agent may be used.

The second internal crosslinking agent is not particularly limited insofar as the second internal crosslinking agent has a lower reactivity than the first internal crosslinking agent, and for example, may be a compound represented by the following Formula 1:

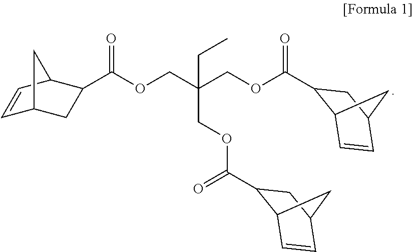 [SMILES: CCC(COC(=O)C1CC2C=CC1C2)(COC(=O)C1CC2C=CC1C2)COC(=O)C1CC2C=CC1C2]

The above-described content of the second internal crosslinking agent may be used.

When the acrylic acid monomer is crosslinked by a reaction with the first internal crosslinking agent, the first internal crosslinking agent is polymerized faster than the acrylic acid monomer, and exhausted. However, when the second internal crosslinking agent having a lower reactivity than the first internal crosslinking agent is used with the first internal crosslinking agent, sufficient crosslinking is achieved even at a later stage of the polymerization reaction, and thus the base resin having uniform crosslinking density may be obtained.

The polymerization reaction of the reactant including the first internal crosslinking agent and the second internal crosslinking agent may be performed at a temperature in the range of 20 to 120° C., and the polymerization reaction is completed within 1 minute to 4 hours.

Polymerization may be initiated by the above-described polymerization initiator. The above-described content of the polymerization initiator may be used.

According to an embodiment of the present invention, a chain transfer agent may be used in the process of polymerization. When polymerization is performed in the presence of the chain transfer agent, and the water-absorbing resin thus prepared is used as an absorbent according to an embodiment of the present invention, an absorbent having high absorption capacity and excellent stability with respect to urine may be obtained. When the chain transfer agent is used, the used amount of the internal crosslinking agent may increase, and crosslinking density may thus increase, and thereby deterioration resistance with respect to urine may be enhanced.

The chain transfer agent used in the present invention is not particularly limited insofar as a chain transfer agent is dissolved in water or an aqueous ethylenic unsaturated monomer, and for example, may include thiols, thiolates, secondary alcohols, amines, phosphorous acid (salts), hypophosphorous acid (salts), etc. More specifically, examples of the chain transfer agent include one or at least two selected from the group consisting of mercaptoethanol, mercapto propanol, dodecyl mercaptan, thioglycol, thiomalic acid, 3-meracaptopropionic acid, isopropanol, sodium phosphite, potassium phosphite, sodium hypophosphite, formic acid and salts thereof. It is preferable to use phosphorus compounds, particularly, a hypophosphite such as sodium hypophosphite in terms of the effect.

The content of the chain transfer agent is not particularly limited, for example, 0.001 to 1 mol %, particularly, 0.005 to 0.3 mol % of the chain transfer agent may be used based on the total monomers included in the acrylic acid polymer for polymerization. When the content of the chain transfer agent is less than 0.001 mol %, the improvement effect due to the use of the chain transfer agent may be low, and when the content of the chain transfer agent is more than 1 mol %, the amount of the water-soluble fraction may increase, and stability may be reduced.

The chain transfer agent may be added sequentially before polymerization or in the process of polymerization.

The method of preparing a water-absorbing resin according to the embodiment of the present invention may further include reaction of a product obtained by the crosslinking and polymerization with a polyvalent metal salt solution to crosslink the product, after the crosslinking and polymerization is complete.

The polyvalent metal salt solution serves to crosslink the unsaturated monomer including the acrylic acid monomer. A general acrylic acid polymer is crosslinked and polymerized by adding the polyvalent metal salt solution, but in such a case the polymerization reaction rate decreases, and a conversion rate is reduced due to the influence of an attractive force between polyvalent metal ions and unsaturated monomers.

However, according to an embodiment of the present invention, such a problem may be prevented because the polyvalent metal salt solution is added to the acrylic acid to polymer for crosslinking after the acrylic acid polymer is crosslinked and polymerized. Accordingly, a resin having more excellent absorbency may be prepared.

The crosslinking reaction between the crosslinked polymerized product and the polyvalent metal salt solution may be performed by impregnating the product formed by the polymerization in the polyvalent metal salt solution or spraying or dripping the polyvalent metal salt solution on the product.

Further, the crosslinking reaction may be performed by kneading the product prepared by crosslinking polymerization with the polyvalent metal salt solution.

Examples of the polyvalent metal salt which may be used in an embodiment of the present invention include aluminum chloride, polyaluminum chloride, aluminum sulfate, aluminum acetate, aluminum potassium bis sulfate, aluminum sodium bis sulfate, potassium alum, ammonium alum, sodium alum, sodium aluminate, calcium chloride, calcium acetate, magnesium chloride, magnesium sulfate, magnesium acetate, zinc chloride, zinc sulfate, zinc acetate, zirconium chloride, zirconium sulfate, zirconium acetate, etc. One or mixtures of two or more thereof may be used.

The content of the polyvalent metal salt is not particularly limited, and for example, may be in the range of 0.001 to 0.1 mol % based on the total content of monomers used in the acrylic acid polymer. When the content of the polyvalent metal salt is less than 0.001 mol %, the effect of improving liquid permeability due to the use of the polyvalent metal salt solution may be low, and when the content of the polyvalent metal salt is more than 0.1 mol %, other physical properties such as absorbency against pressure or the like may be reduced.

The method of preparing the water-soluble resin according to the embodiment of the present invention may further include neutralization of the acrylic acid monomer.

Neutralization may be performed by adding the above-described alkali, and may be performed such that the neutralization ratio of an acid group (mol % of neutralized acid groups based on the total acid groups) is in the range of 20 to 100 mol %, for example, 30 to 95 mol %, and particularly, in the range of 40 to 80 mol %. When the neutralization ratio is less than 20%, absorption capacity of the resin is reduced, when the neutralization ratio is more than 80 mol %, most of the resin may be dissolved in water.

Thereafter, the water-absorbing resin may be prepared by further including a process well known in the related field.

For example, the method of preparing the water-absorbing resin may include: fragmentation of the base resin prepared by crosslinking and polymerization; drying and grinding of the fragmented base resin to prepare a particulate base resin; and crosslinking of the surface of the particulate base resin.

Examples of a crusher which may be used to fragment the base resin include shear granulation machines, impact crushers, high speed rotation crushers or the like, but are not limited thereto.

For example, a crusher provided with at least one function of cutting, shearing, impact and friction may be used, and, particularly, a crusher provided with a function of cutting or shearing may be used. A crusher provided with a compressor may be used in the part where a high effect of cutting and shearing is expected. Particularly, device having the effect of grinding performed by shearing with a plurality of rotary blades and fixed blades may be used in the above-described crushers.

The fragmentation of the base resin may be performed such that an average particle size of the base resin is in the range of 1 to 20 mm.

The rotation speed of rotary blades is, for example, in the range of 3.0 to 200 m/s, and particularly 5.0 to 150 m/s.

For example, the fragmented base resin may be dried at a temperature in the range of 50 to 250° C., for example, 100 to 170° C. When a drying temperature is less than 50° C., drying time may be extended, resulting in a decrease in productivity.

Various drying methods are used to obtain a target content of water, and may include heat drying, hot-air drying, vacuum drying, infrared drying, microwave drying, drying by a drum drier, azeotropic dehydration with a hydrophobic organic solvent, and high humidity drying using high temperature steam, but the present invention is not limited thereto.

The fragmented base resin may be ground using the same method as the above-described examples of fragmentation methods.

The base resin may be ground such that the particle size of the base resin is in the range of 150 to 800 μm, for example, 150 to 600 μm, and particularly 180 to 500 μm. The ratio of particles having the particle size of less than 150 μm may be in the range of 0 to 8 wt %, for example, 0 to 5 wt % based on the total weight of the particulate base resin.

Thereafter, the surface of the particulate base resin is crosslinked.

In the present invention, surface crosslinking refers to increasing the crosslinking density around the surface of particle as compared to that of the side of particle. More particularly, a compound (surface crosslinking agent) including two or more functional groups which may react with and bond to acid groups or salts thereof (e.g., carboxyl groups or salts thereof) contained in the particulate base rein in its molecules is added to the surface of particles so as to form a new crosslink. The absorbency against pressure may be improved by the above-described surface crosslinking treatment.

The above-described content of the surface crosslinking agent may be used.

For example, surface crosslinking may be performed at a temperature in the range of 150 to 250° C. for 1 minute to 4 hours.

The method of preparing the water-absorbing resin according to another embodiment of the present invention may include: crosslinking and polymerization of an unsaturated monomer including an acrylic acid monomer in the presence of an internal crosslinking agent; and reaction of a product obtained by the crosslinking and polymerization with a polyvalent metal salt solution to crosslink the product.

Examples of the acrylic acid monomer include the above-described monomers. In addition, the above-described unsaturated monomers may be copolymerized together. The above-described content of the acrylic acid monomer may be used.

The above-described content of the internal crosslinking agent may be used.

The above-described content of the above-described polymerization initiator and chain transfer agent may be used in the process of crosslinking and polymerization.

When the crosslinking and polymerization is completed, a reaction of the thus obtained product and a polyvalent metal salt solution is performed to crosslink the product.

The above-described problem may be suppressed by adding the polyvalent metal salt solution after crosslinking and polymerization.

The above-described content of the polyvalent metal salt may be used.

The crosslinking reaction between the crosslinked polymerized product and the polyvalent metal salt solution may be performed by impregnating the product formed by the polymerization in the polyvalent metal salt solution or spraying or dripping the polyvalent metal salt solution on the product.

Further, the crosslinking reaction may be performed by kneading the product prepared by crosslinking polymerization with the polyvalent metal salt solution.

Hereinafter, the present invention will be described in detail in conjunction with the examples.

### EXAMPLES AND COMPARATIVE EXAMPLES

A polymerization initiator, a first internal crosslinking agent and a second internal crosslinking agent having a lower reactivity than the first internal crosslinking agent were added to an aqueous solution including an acrylic acid monomer having compositions listed in the following Table 1. Thereafter, a mixture was maintained for 6 minutes after 500 mJ/cm² of light was radiated thereto using a high pressure mercury lamp, and the thus prepared gel sheet having a thickness of 20 mm was used as a base resin, or 500 g of the thus prepared gel sheet was impregnated in a water tank filled with 1 liter of a 0.1 wt %-metal salt (zinc sulfate or aluminum sulfate) solution for 10 seconds to prepare a base resin, or 500 g of the thus prepared gel sheet was kneaded with 50 g of a 0.01 wt %-metal salt (zinc sulfate or aluminum sulfate) solution with respect to an absorber not including water at 40 rpm for 2 minutes using a kneading machine rotating on the horizontal axis to prepare a base resin.

The thus obtained base resin was finely fragmented for 30 minutes using a shear force. Thereafter, a fragmented base resin was laid out on stainless steel wire gauze having a pore size of 600 μm to have a thickness of about 30 mm, and was dried for 5 hours in a hot air oven at 160° C. Subsequently, the base resin was ground using a grinder, and classified using ASTM standard mesh to prepare a particulate base resin having a particle diameter in the range of 150 to 800 μm.

100 g of the thus obtained particulate base resin and a mixed solution including a surface crosslinking agent (1,3-propanediol/methanol/water=0.5/1/3 g) were put into a mixing machine, and were stirred at 100 rpm for 1 minute to perform surface crosslinking. Thereafter, the mixture was reacted at a relative humidity of 1.5% for 60 minutes in a hot air oven. The dried powders were classified using ASTM standard mesh to prepare a water-absorbing resin having a particle diameter in the range of 150 to 800 μm.

TABLE 1

| | | | | | | | | | Surface |
|---|---|---|---|---|---|---|---|---|---|
| | | | | | | | | | crosslink- |
| | | | | | | | | | ing agent |
| | | | First | | | | | | (E) |
| | Acrylic acid | | inter- | | | | | | parts by |
| | monomer solution | | nal | Second | | | | | weight |
| | (A) | | cross- | internal | | | | | based on |
| | Density | | linking | crosslinking | | Polyvalent | | Polymeri- | 100 parts |
| | of | Acrylic acid/ | agent | agent | | metal salt | | zation | by |
| Class- | mono- | Sodium | (B) | (C) | | solution | | initiator | weight |
| ifica- | mer | acrylate | mol | Compo- | mol | Impreg- | Knead- | (D) | of base |
| tion | wt % | mol % | % | nent | % | nating | ing | mol % | resin |
| Ex- | 40 | 25/75 | 0.03 | — | — | Zn | — | 0.05 | 0.5/1/3 |
| ample | | | | | | solution | | | |
| 1 | | | | | | | | | |
| Ex- | 40 | 25/75 | 0.03 | — | — | Al | — | 0.05 | 0.5/1/3 |
| ample | | | | | | solution | | | |
| 2 | | | | | | | | | |
| Ex- | 40 | 25/75 | 0.03 | — | — | — | Zn | 0.05 | 0.5/1/3 |
| ample | | | | | | | solution | | |
| 3 | | | | | | | | | |
| Ex- | 40 | 25/75 | 0.03 | — | — | — | Al | 0.05 | 0.5/1/3 |
| ample | | | | | | | solution | | |
| 4 | | | | | | | | | |
| Ex- | 40 | 25/75 | 0.02 | C-1 | 0.01 | — | — | 0.05 | 0.5/1/3 |
| ample | | | | | | | | | |
| 5 | | | | | | | | | |
| Ex- | 40 | 25/75 | 0.02 | C-1 | 0.01 | Zn | — | 0.05 | 0.5/1/3 |
| ample | | | | | | solution | | | |
| 6 | | | | | | | | | |
| Ex- | 40 | 25/75 | 0.02 | C-1 | 0.01 | Al | — | 0.05 | 0.5/1/3 |
| ample | | | | | | solution | | | |
| 7 | | | | | | | | | |
| Com- | 40 | 25/75 | 0.03 | — | — | — | — | 0.05 | 0.5/1/3 |
| para- | | | | | | | | | |
| tive | | | | | | | | | |
| Ex- | | | | | | | | | |
| ample | | | | | | | | | |
| 1 | | | | | | | | | |
| Com- | 40 | 25/75 | 0.04 | — | — | — | — | 0.05 | 0.5/1/3 |
| para- | | | | | | | | | |
| tive | | | | | | | | | |
| Ex- | | | | | | | | | |
| ample | | | | | | | | | |
| 2 | | | | | | | | | |
| Com- | 40 | 25/75 | 0.07 | — | — | — | — | 0.05 | 0.5/1/3 |
| para- | | | | | | | | | |
| tive | | | | | | | | | |
| Ex- | | | | | | | | | |
| ample | | | | | | | | | |
| 3 | | | | | | | | | |
| Com- | 40 | 25/75 | 0.10 | — | — | — | — | 0.05 | 0.5/1/3 |
| para- | | | | | | | | | |
| tive | | | | | | | | | |
| Ex- | | | | | | | | | |
| ample | | | | | | | | | |
| 4 | | | | | | | | | |

B: Trimethylolpropane methacrylate
C-1: Trimethylolpropane tri(norborn-2-ene-5-carboxylate) 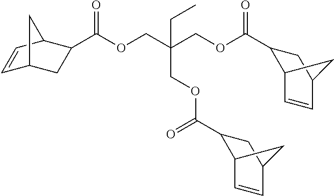 [SMILES: CCC(COC(=O)C1CC2C=CC1C2)(COC(=O)C1CC2C=CC1C2)COC(=O)C1CC2C=CC1C2]
D: Irgacure 184
E: 1,3-propanediol/methanol/water

### Experimental Example

### (1) Measurement of Water-Soluble Fraction

The water-soluble fraction of the water-absorbing resin was measured by extraction under pressure.

2 g of the water-absorbing resins of the examples and comparative examples dehumidified and dried at 80° C. for 3 hours and 200 g of water were put into a planetary mixer (UNITECH CO., LTD.), and stirred at 50 rpm for 1 hour.

The thus prepared solution was put into a container mounted with a 1.2 μm-glass filter paper, a solution passing through a filter was slowly condensed using nitrogen gas at 35° C. and 5 psi, and the extracted component was dehumidified and dried to measure a water-soluble fraction according to the following Expression 3.

Water-soluble fraction (wt %)=(weight of extracted component/weight of initial dried resin)*100 [Expression 3]

### (2) Water-Soluble Fraction Shear Index Test

1 g of the water-absorbing resin and 400 mL of ultrapure water were put into an 1 L-beaker, and stirred for 1 hour to extract a solution including a water-soluble fraction under pressure of 5 psi, and the viscosity (B) of the solution including the water-soluble fraction at a shear rate of 10/s was measured under a condition of 25° C. using an Advanced Rheometric Expansion System.

Thereafter, the solution was dried in a convection oven at 90° C. for 6 hours, and then a homogeneous solution was prepared such that the ultrapure water contained a water-soluble fraction at 0.2 wt %. A test was performed on the solution under a condition of 25° C. while a shear rate was set to include 10/s and 100/s using the Advanced Rheometric Expansion System to measure the shear complex viscosity (Vis(10) and Vis(100)) (A) of the solution and a water-soluble fraction shear index represented by the following Expression 1.

A/B [Expression 1]

(in Expression 1, A is an absolute gradient of viscosity with respect to a shear rate of an ultrapure water solution with a content of a water-soluble fraction of 0.2 wt % of the water-absorbing resin, and is represented by the following Expression 2, and B is a viscosity at a shear rate of 10/s of an ultrapure water solution including a water-soluble fraction of a water-absorbing resin after immersing a water-absorbing resin in ultrapure water of which the weight is 400 times the weight of the water-absorbing resin and stirring a mixed solution at 300 rpm for 60 minutes)

(Vis(100)−Vis(10))/(100−10) [Expression 2]

(in Expression 2, Vis (100) is a viscosity of an aqueous solution at a shear rate of 100/s, and Vis (10) is a viscosity of an aqueous solution at a shear rate of 10/s).

### (3) Measurement of Absorbency Against Pressure

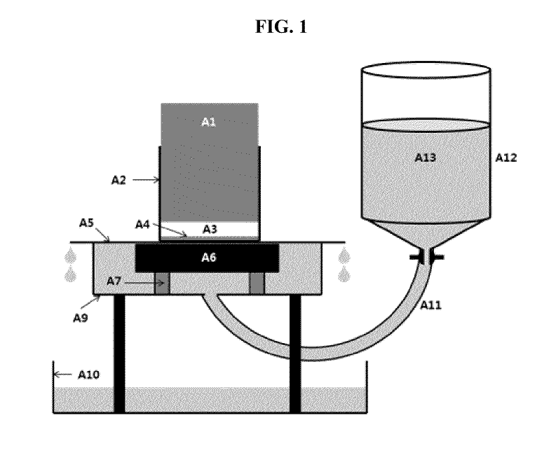

Absorbency against pressure was measured using a device of FIG. 1. The measurement device includes A1: weight (0.3 psi), A2: cylinder, A4: non-woven fabric, A5: paper filter, A6: glass filter, A7: glass filter support, A8: cylinder support, A9: container, A10: connector and A11: water storage tank, and methods of installation and measurement of absorbency against pressure are as follows.

The cylinder support A8 and water storage tank A11 were connected by the connector A10, and each device had a hole such that 0.9% of a saline solution A12 in the water storage tank may flow. The cylinder support A8 was positioned in the container A9, and the glass filter support A7 was used such that the height of the top of the glass filter A6 is the same as that of the cylinder support A8. Thereafter, the paper filter A5 of which the surface is larger than the surface of the top of the cylinder support A8 was positioned. A cover of the water storage tank A11 was opened to flow the saline solution A12, and the saline solution A12 flowing through tubes filled to the top of the cylinder support A8. An excess amount of the saline solution naturally fell to the outside of the container by the paper filter A5. Air bubbles generated between the glass filter A6 and paper filter A5 were removed.

The bottom of the cylinder A2 is covered by the non-woven fabric A4, 0.9 g of a water-absorbing resin w0 was spread out on the upper part A3 of the non-woven fabric A4, the cylinder was positioned on the paper filter, and then the weight A1 is immediately positioned thereon.

A hydrous gel in the cylinder was collected after 1 hour to measure a weight (w1; weight of water-absorbing resin after absorption), and a value obtained by deducting the weight of a measurement sample (w0; weight of water-absorbing resin before absorption) from the weight w1 was divided by the weight w0 of the measurement sample to find the value of absorbency against pressure.

Absorbency against pressure (g/g)=(weight of water-absorbing resin after absorption (g))−weight of water-absorbing resin before absorption (g). [Expression 4]

### (4) Measurement of Absorbency Against Non-Pressure (CRC) (EDANA WSP 241.2.R3)

0.2 g of the water-absorbing resin prepared in the examples and comparative examples was put in a tea bag and sealed, and immersed in a 0.9 wt %-saline solution for 30 minutes for absorption.

Thereafter, the weight of the tea bag was measured after centrifugation in a centrifuge set to 250G

The same process was performed with respect to an empty tea bag to measure the weight of the empty tea bag, and absorbency against non-pressure was calculated according to the following Expression 3.

Absorbency against non-pressure (g/g)={(weight of water-absorbing resin+tea bag (g))−weight of empty tea bag (g)}/weight of dried resin (g) [Expression 3]

### (5) Measurement of Permeability

The same method as the method of measurement of permeability in U.S. Pat. No. 5,562,646 was used.

TABLE 2

| | | Water- | Absorbency | Absorbency | Perme- |
|---|---|---|---|---|---|
| | A/B | soluble | against | against non- | ability |
| Classi- | (×10⁻⁵ | fraction | pressure | pressure | (×10⁻⁸ |
| fication | s) | (wt %) | (g/g) | (g/g) | cm²) |
| Example 1 | 0.3 | 12 | 34 | 37 | 70 |
| Example 2 | 0.7 | 10 | 36 | 39 | 68 |
| Example 3 | 0.4 | 8 | 35 | 38 | 72 |
| Example 4 | 0.8 | 6 | 34 | 40 | 69 |
| Example 5 | 2.0 | 15 | 35 | 38 | 65 |
| Example 6 | 5.0 | 6 | 32 | 36 | 73 |
| Example 7 | 9.5 | 4 | 30 | 35 | 79 |
| Comparative | 0.05 | 28 | 28 | 36 | 5 |
| Example 1 | | | | | |
| Comparative | 0.07 | 24 | 30 | 32 | 8 |
| Example 2 | | | | | |
| Comparative | 0.09 | 18 | 20 | 30 | 20 |
| Example 3 | | | | | |
| Comparative | 10.3 | 6 | 15 | 22 | 43 |
| Example 4 | | | | | |

Referring to Table 2, it was determined that all the A/Bs, water-soluble fractions, and absorbency against pressure of the water-absorbing resins prepared in Examples 1 to 7 were in the range according to an embodiment of the present invention, and thus the water-absorbing resins had excellent absorbency and high absorption capacity. Further, it may be determined that permeability was significantly high, and thus water was easily and evenly spread between the absorptive resin particles to be absorbed.

However, in the case of the water-absorbing resins prepared in Comparative Examples 1 and 2, the A/B was less than 0.1×10⁻⁵(s), which indicates that an amount of the water-soluble fraction was significantly increased. In the case of the water-absorbing resin prepared in Comparative Example 3, absorbency against pressure was largely reduced. In the case of the water-absorbing resin prepared in Comparative Example 4, an amount of the water-soluble fraction was low, but absorbency against pressure and absorbency against non-pressure were significantly decreased.

The water-absorbing resin according to an embodiment of the present invention has significantly improved absorbency due to a uniform crosslinking structure and a suitable degree of crosslinking.

Since the mobility of the water soluble fraction of the water-absorbing resin according to an embodiment of the present invention is suppressed, hygiene products such as diapers made of the water-absorbing resin according to an embodiment of the present invention can have excellent hygiene.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of preparing a water-absorbing resin, the method comprising:
crosslinking and polymerizing an unsaturated monomer including an acrylic acid monomer in the presence of a first internal crosslinking agent and a second internal crosslinking agent having a lower reactivity than the first internal crosslinking agent.

2. The method of claim 1, wherein the first internal crosslinking agent is one or more selected from the group consisting of N,N′-methylenebis(meth)acrylamide, (poly)ethylene glycol di(meth)acrylate, (poly)propylene glycol di(meth)acrylate, trimethylolpropane tri(meth)acrylate, glycerol tri(meth)acrylate, glycerol acrylate methacrylate, ethyleneoxide modified trimethylolpropane tri(meth)acrylate, pentaerythritol hexa(meth)acrylate, triallyl cyanurate, triallyl isocyanurate, triallyl phosphate, triallylamine, poly(meth)allyloxy alkane, (poly)ethylene glycol diglycidyl ether, glycerol diglycidyl ether, ethylene glycol, polyethylene glycol, propylene glycol, glycerin, pentaerythritol, ethylenediamine, ethylene carbonate, propylene carbonate, polyethyleneimine and glycidyl (meth)acrylate.

3. The method of claim 1, wherein the second internal crosslinking agent is a compound represented by the following Formula 1:

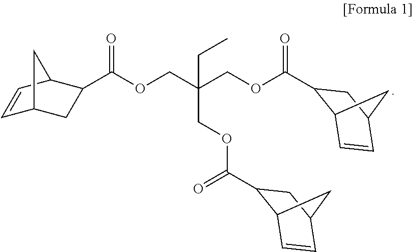 [SMILES: CCC(COC(=O)C1CC2C=CC1C2)(COC(=O)C1CC2C=CC1C2)COC(=O)C1CC2C=CC1C2]

4. The method of claim 1, wherein a content of the second internal crosslinking agent is in a range of 0.001 to 2 mol % based on a total content of the unsaturated monomer.

5. The method of claim 1, further comprising:
reacting a product obtained by the crosslinking and polymerization with a polyvalent metal salt solution to crosslink the product.

6. The method of claim 5, wherein the reaction with the polyvalent metal salt solution comprises impregnating the product in the polyvalent metal salt solution or spraying or dripping the polyvalent metal salt solution on the product.

7. The method of claim 5, wherein the reaction with the polyvalent metal salt solution comprises kneading the product with the polyvalent metal salt solution.

8. The method of claim 5, wherein the polyvalent metal salt solution is solution of one or more polyvalent metal salt selected from the group consisting of aluminum chloride, polyaluminum chloride, aluminum sulfate, aluminum acetate, aluminum potassium bis sulfate, aluminum sodium bis sulfate, potassium alum, ammonium alum, sodium alum, sodium aluminate, calcium chloride, calcium acetate, magnesium chloride, magnesium sulfate, magnesium acetate, zinc chloride, zinc sulfate, zinc acetate, zirconium chloride, zirconium sulfate and zirconium acetate.

9. A water-absorbing resin prepared by the method of claim 1.

10. A method of preparing a water-absorbing resin, the method comprising:
crosslinking and polymerizing an unsaturated monomer including an acrylic acid monomer in the presence of an internal crosslinking agent; and
reacting a product obtained by the crosslinking and polymerization with a polyvalent metal salt solution to crosslink the product.

11. The method of claim 10, wherein the internal crosslinking agent is one or more selected from the group consisting of N,N′-methylenebis(meth)acrylamide, (poly)ethylene glycol di(meth)acrylate, (poly)propylene glycol di(meth)acrylate, trimethylolpropane tri(meth)acrylate, glycerol tri(meth)acrylate, glycerol acrylate methacrylate, ethyleneoxide modified trimethylolpropane tri(meth)acrylate, pentaerythritol hexa(meth)acrylate, triallyl cyanurate, triallyl isocyanurate, triallyl phosphate, triallylamine, poly(meth)allyloxy alkane, (poly)ethylene glycol diglycidyl ether, glycerol diglycidyl ether, ethylene glycol, polyethylene glycol, propylene glycol, glycerin, pentaerythritol, ethylenediamine, ethylene carbonate, propylene carbonate, polyethyleneimine and glycidyl (meth)acrylate.

12. The method of claim 10, wherein the reaction with the polyvalent metal salt solution is performed by impregnating the product in the polyvalent metal salt solution or spraying or dripping the polyvalent metal salt solution on the product.

13. The method of claim 10, wherein the reaction with the polyvalent metal salt solution is performed by kneading the product with the polyvalent metal salt solution.

14. The method of claim 9, wherein the polyvalent metal salt solution is solution of one or more polyvalent metal salt selected from the group consisting of aluminum chloride, polyaluminum chloride, aluminum sulfate, aluminum acetate, aluminum potassium bis sulfate, aluminum sodium bis sulfate, potassium alum, ammonium alum, sodium alum, sodium aluminate, calcium chloride, calcium acetate, magnesium chloride, magnesium sulfate, magnesium acetate, zinc chloride, zinc sulfate, zinc acetate, zirconium chloride, zirconium sulfate and zirconium acetate.

15. A water-absorbing resin prepared by the method of claim 10.

16. A water-absorbing resin, in which a content of a water-soluble fraction is 15 wt % or less based on the total weight of the resin, an absorbency against pressure at 0.3 psi with respect to a saline solution including sodium chloride at 0.9 wt % is 25 g/g or more, and a water-soluble fraction shear index A/B represented by the following Expression 1 is in a range of 0.1×10⁻⁵ (s) to 10×10⁻⁵ (s):
A/B [Expression 1]
where A is an absolute gradient of viscosity with respect to a shear rate of an ultrapure water solution with a content of a water-soluble fraction of 0.2 wt % of the water-absorbing resin, and is represented by the following Expression 2, and B is a viscosity at a shear rate of 10/s of an ultrapure water solution including a water-soluble fraction of a water-absorbing resin after immersing a water-absorbing resin in ultrapure water of which the weight is 400 times the weight of the water-absorbing resin and stirring a mixed solution at 300 rpm for 60 minutes;
(Vis(100)−Vis(10))/(100−10) [Expression 2]
where Vis (100) is a viscosity of an aqueous solution at a shear rate of 100/s, and Vis (10) is a viscosity of an aqueous solution at a shear rate of 10/s.

17. The water-absorbing resin of claim 16, wherein the water-absorbing resin is prepared by grinding a base resin comprising an acrylic acid polymer and carrying out surface crosslinking of the base resin.

18. The water-absorbing resin of claim 16, wherein the A/B is in a range of 0.5×10⁻⁵ (s) to 7×10⁻⁵ (s).

19. The water-absorbing resin of claim 16, wherein the A/B is in a range of 1×10⁻⁵ (s) to 5×10⁻⁵ (s).

20. The water-absorbing resin of claim 16, wherein the absorbency against pressure is in a range of 25 to 45 g/g.
